(19) United States
(12) Patent Application Publication
(10) Pub. No.: US 2025/0291421 A1
(43) Pub. Date: Sep. 18, 2025

(54) INPUT APPARATUS AND METHOD

(71) Applicant: HTC Corporation, Taoyuan City (TW)

(72) Inventor: Yun-Ting WANG, Taoyuan City (TW)

(21) Appl. No.: 18/605,851

(22) Filed: Mar. 15, 2024

(51) Int. Cl. G06F 3/01; G06F 3/04815; G06V 40/20

(52) U.S. Cl. CPC G06F 3/017; G06F 3/011; G06F 3/04815; G06V 40/28

(57) ABSTRACT

An input apparatus is configured to execute the following operations. A first gesture of a user is determined based on first hand images of hand images. In response to the first gesture matching an activating gesture, a virtual keyboard is generated on a virtual plane at a first time point, and the virtual plane is generated based on a palm position corresponding to the first gesture. A second gesture of the user is determined based on second hand images corresponding to a second time point of the hand images, and the first time point is earlier than the second time point. In response to the second gesture matching a typing gesture, an input command corresponding to the typing gesture is generated based on a movement between the second gesture and the virtual keyboard.

### BACKGROUND

### Field of Invention

The present disclosure relates to an input apparatus and method. More particularly, the present disclosure relates to an input apparatus and method based on the gesture of the user.

### Description of Related Art

In the present virtual reality and/or augmented reality technology, if a virtual object needs to be generated at a specific location in the real environment, it is necessary to rely on a specific pattern or a physical plane as a reference object. Accordingly, the generated virtual object will move with the reference object.

However, the present technology limits the environment for generating virtual objects, and in the application of virtual reality and/or augmented reality technology, the operation of inputting or editing text is more complicated and unintuitive than using a physical keyboard.

In view of this, how to provide an intuitive virtual keyboard interaction technology that is not limited to the physical environment is the goal that the industry strives to work on.

### SUMMARY

The disclosure provides an input apparatus, comprising a camera and a processor. The camera is configured to capture a plurality of hand images of a user. The processor is communicatively connected to the camera and is configured to execute the following operations: determining a first gesture of the user based on a plurality of first hand images of the hand images; in response to the first gesture matching an activating gesture, generating a virtual keyboard on a virtual plane at a first time point, wherein the virtual plane is generated based on a palm position corresponding to the first gesture; determining a second gesture of the user based on a plurality of second hand images corresponding to a second time point of the hand images, wherein the first time point is earlier than the second time point; and in response to the second gesture matching a typing gesture, generating an input command corresponding to the typing gesture based on a movement between the second gesture and the virtual keyboard.

The disclosure further provides an input method being adapted for use in an electronic apparatus and comprising: capturing a plurality of hand images of a user; determining a first gesture of the user based on a plurality of first hand images of the hand images; in response to the first gesture matching an activating gesture, generating a virtual keyboard on a virtual plane at a first time point, wherein the virtual plane is generated based on a palm position corresponding to the first gesture; determining a second gesture of the user based on a plurality of second hand images corresponding to a second time point of the hand images, wherein the first time point is earlier than the second time point; and in response to the second gesture matching a typing gesture, generating an input command corresponding to the typing gesture based on a movement between the second gesture and the virtual keyboard.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an input apparatus according to a first embodiment of the present disclosure.

FIG. 2 is a situational diagram illustrating the input apparatus applied in a head mounted display according to some embodiments of the present disclosure.

FIG. 3 is a flow diagram illustrating the operations of the input apparatus according to some embodiments of the present disclosure.

FIG. 4 is a schematic diagram illustrating an activating gesture according to some embodiments of the present disclosure.

FIG. 5 is a flow diagram illustrating details of determining whether the user's gesture matches the activating gesture according to some embodiments of the present disclosure.

FIG. 6 is a flow diagram illustrating details of generating a virtual keyboard according to some embodiments of the present disclosure.

FIGS. 7A, 7B, 8, 9A, and 9B are situational diagrams illustrating editing gestures according to some embodiments of the present disclosure.

FIG. 10 is a flow diagram illustrating details of executing a typing function according to some embodiments of the present disclosure.

FIG. 11 is a schematic diagram illustrating marking the keys corresponding to fingers on the virtual keyboard according to some embodiments of the present disclosure.

FIG. 12 is a schematic diagram illustrating fingers typing on the virtual keyboard according to some embodiments of the present disclosure.

FIG. 13A-13C are schematic diagrams illustrating closing gestures according to some embodiments of the present disclosure.

FIG. 14 is a flow diagram illustrating an input method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

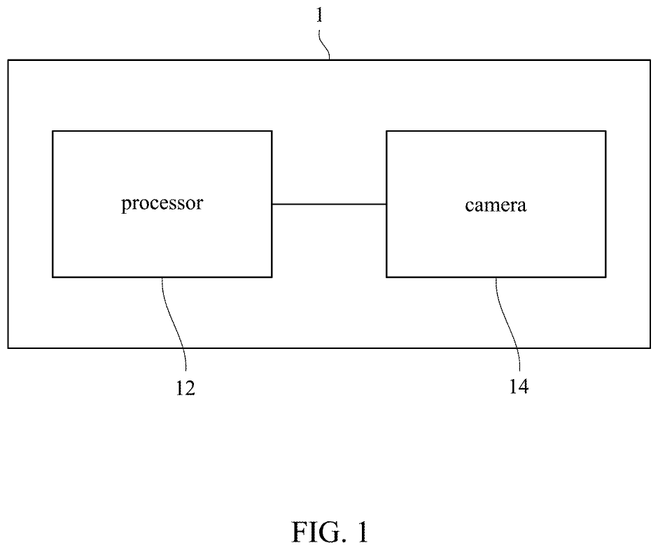

Reference is made to FIG. 1. FIG. 1 is a schematic diagram illustrating an input apparatus 1 according to a first embodiment of the present disclosure. The input apparatus 1 comprises a processor 12 and a camera 14. The input apparatus 1 is configured to generate a virtual keyboard based on a gesture of a user and execute the corresponding function.

In some embodiments, the processor 12 can comprise a central processing unit (CPU), a graphics processing unit (GPU), a multi-processor, a distributed processing system, an application specific integrated circuit (ASIC), and/or a suitable processing unit.

The camera 14 is configured to capture images in a space, and the input apparatus 1 is able to determine the position of an object in the three-dimensional space. In some embodiments, the camera 14 can comprise a depth camera configured to capture a depth image or multiple cameras configured to capture two-dimensional images. Accordingly, the input apparatus 1 can determine the position of the object based on the depth image or the combined two-dimensional images. More specifically, the input apparatus 1 is able to determine the gesture of the user based on the images.

In some embodiments, the processor 12 calculates a plurality of hand joint points in the hand images; and the processor 12 determines the first gesture and the second gesture based on the hand joint points.

For example, the processor 12 of the input apparatus 1 can determine the gesture of the user based on the images captured by the camera 14 by using an image recognition model. In an embodiment, the image recognition model can identify the positions of the hand joint points such as palms, knuckles, and fingertips and construct the gesture of the user accordingly.

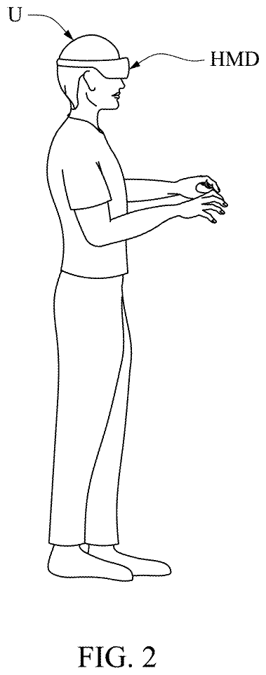

Reference is made to FIG. 2. FIG. 2 is a situational diagram illustrating the input apparatus 1 applied in a head mounted display HMD according to some embodiments of the present disclosure. In some embodiments, the input apparatus 1 can be configured in the head mounted display HMD. Therefore, a user U can control the input apparatus 1 in the head mounted display HMD to display a virtual keyboard by making specific gestures and execute functions related to the virtual keyboard. It is noted that, the virtual keyboard can be displayed by a display unit of the head mounted display HMD.

It is noted that, the input apparatus 1 can be applied to other technical field such as computers. For clarity, the head mounted display HMD is taken as an example in the present disclosure.

In order to complete the functions mentioned above, the processor 12 of the input apparatus 1 is configured to execute the following operations: determining a first gesture of the user based on a plurality of first hand images of the hand images; in response to the first gesture matching an activating gesture, generating a virtual keyboard on a virtual plane at a first time point, wherein the virtual plane is generated based on a palm position corresponding to the first gesture; determining a second gesture of the user based on a plurality of second hand images corresponding to a second time point of the hand images, wherein the first time point is earlier than the second time point; and in response to the second gesture matching a typing gesture, generating an input command corresponding to the typing gesture based on a movement between the second gesture and the virtual keyboard.

For example, after the processor 12 recognizes the user's hands making the activating gesture, the processor 12 generates the virtual keyboard below the user's palms (e.g., the processor 12 controls the display of the head mounted display HMD to display the image of a keyboard). Next, when the processor 12 recognizes the user's hands making typing gesture on the virtual keyboard, the processor 12 determines which function of a key to be triggered based on the movement positions of the user's hands.

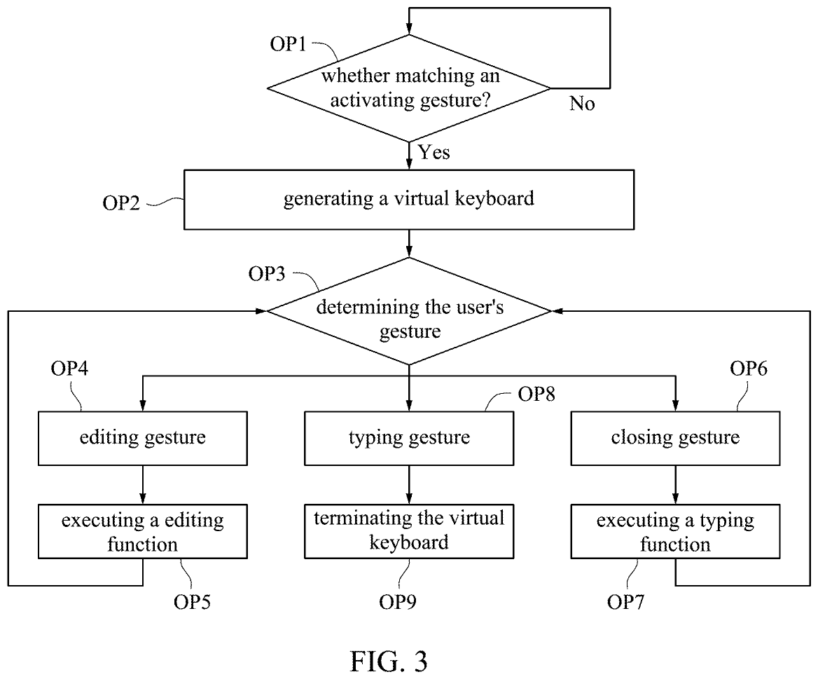

About the details of the operations please refer to FIG. 3. FIG. 3 is a flow diagram illustrating the operations of the input apparatus 1 according to some embodiments of the present disclosure, wherein the input apparatus 1 is configured to execute operations OP1-OP9. In order to complete the functions mentioned above, as shown in FIG. 3, first, the processor 12 of the input apparatus 1 executes an operation OP1, determining whether the hands of the user U match an activating gesture based on first hand images (i.e., the hand images captured when the virtual keyboard has not been generated) captured by the camera 14, wherein the activating gesture can be a predefined gesture.

When the user's hands are making the activating gesture, the processor 12 executes an operation OP2, generating a virtual keyboard. In contrast, if the hands of the user U are not making the activating gesture, the processor 12 continues to execute the operation OP1.

After generating the virtual keyboard, the processor 12 further executes the operation OP3, determining the subsequent gesture of the user U based on the second hand images (i.e., the hand images captured after the virtual keyboard has been generated) captured by the camera 14.

In some embodiments, in response to the second gesture matching one of a plurality of editing gestures, the processor 12 executes an editing function corresponding to the one of the editing gestures. Specifically, if the gesture of the user U matches the editing gestures (i.e., the operation OP4), the processor 12 executes the operation OP5, executing an editing function corresponding to one of the editing gestures. More specifically, the editing gestures can comprise specific gestures corresponding to editing functions such as copy, paste, and moving cursor. Accordingly, when one or both of hands of the user U matches one of the specific gestures, the processor 12 executes the corresponding editing function (copy, paste, or moving cursor). Furthermore, after the operation OP5, the input apparatus 1 returns to the operation OP3 to determine the subsequent gesture of the user U continuously.

On the other hand, if the gesture of the user U matches the typing gesture (i.e., the operation OP6), the processor 12 executes the operation OP7, executing a typing function of the virtual keyboard. Specifically, the input apparatus 1 can detect the interactions between the gesture of the user U and the virtual keyboard, thereby determining which key on the virtual keyboard is triggered by the user U. Furthermore, after the operation OP7, the input apparatus 1 returns to the operation OP3 to determine the subsequent gesture of the user U continuously.

In some embodiments, in response to the second gesture matching a closing gesture, the processor 12 terminates the virtual keyboard. Specifically, when the processor 12 determines that the gesture of the user U matches the specific closing gesture in the operation OP8, the processor 12 executes the operation OP9, terminating the virtual keyboard to end editing text.

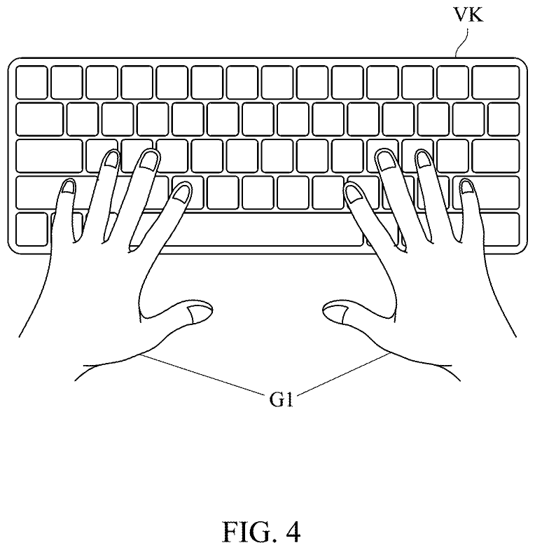

About the activating gesture mentioned in the operation OP1, please refer to FIG. 4. FIG. 4 is a schematic diagram illustrating an activating gesture G1 according to some embodiments of the present disclosure. As shown in FIG. 4, the activating gesture G1 can be set as a gesture that both hands keep the palms roughly on the same plane and show a pose ready for typing. In other words, in response to determining that the two planes constructed by the two palms of the user U are roughly coincided with each other, the input apparatus 1 determines that the gesture of the user U matches the activating gesture. Moreover, when the user U makes the activating gesture and maintains it for a period of time (e.g., 1 second), the input apparatus 1 can generate a virtual keyboard VK below both hands of the user U. Accordingly, the input apparatus 1 can generate the virtual keyboard VK on the virtual plane without a specific pattern or a physical plane.

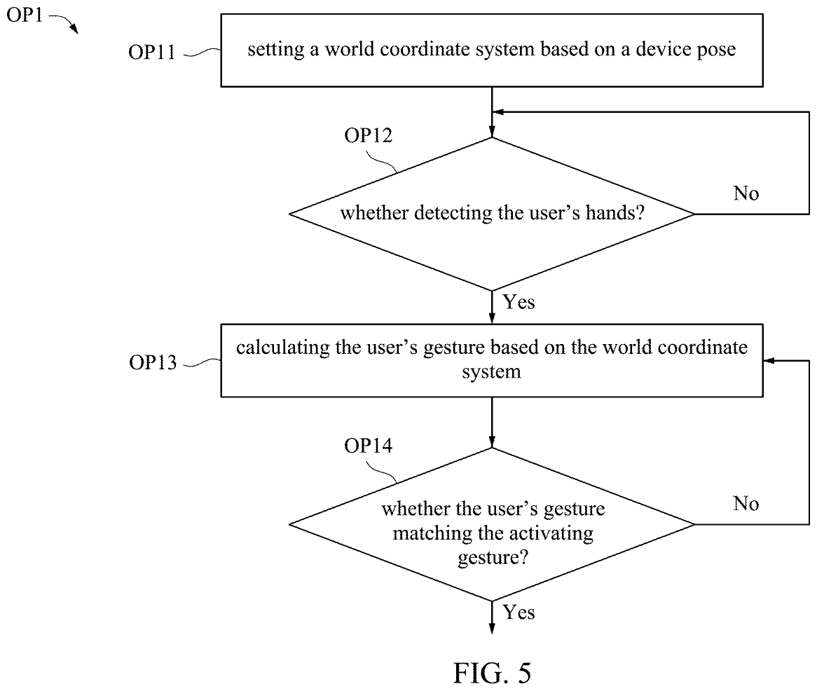

Reference is made to FIG. 5, in some embodiments, the operation OP1 further comprises the operation OP11-OP14.

First, the processor 12 of the input apparatus 1 executes the operation OP11, setting a world coordinate system based on a device pose. For example, the processor 12 can determine the pose of the input apparatus 1 (can also be the pose of the head mounted display HMD) based on information detected by a gyroscope, an inertial measurement unit, or other unit in the head mounted display HMD and set the world coordinate system with the input apparatus 1 as an origin point.

Next, the processor 12 executes the operation OP12, determining whether the user's hands are detected based on the images captured by the camera 14. When the processor 12 detects the hands of the user U, the processor 12 executes the operation OP13, calculating the gesture of the user U based on the world coordinate system.

Finally, the processor 12 executes the operation OP14, determining whether the gesture of the user U matches the activating gesture (e.g., the activating gesture shown in FIG. 4) based on the first hand images. If the gesture of the user U matches the activating gesture, the processor 12 executes the operation OP12. In contrast, if the gesture of the user U does not match the activating gesture, the processor 12 returns to the operation OP13 to determine the subsequent gesture of the user U continuously.

Therefore, the processor 12 can determine whether the gesture of the user U matches the activating gesture through the operation OP1.

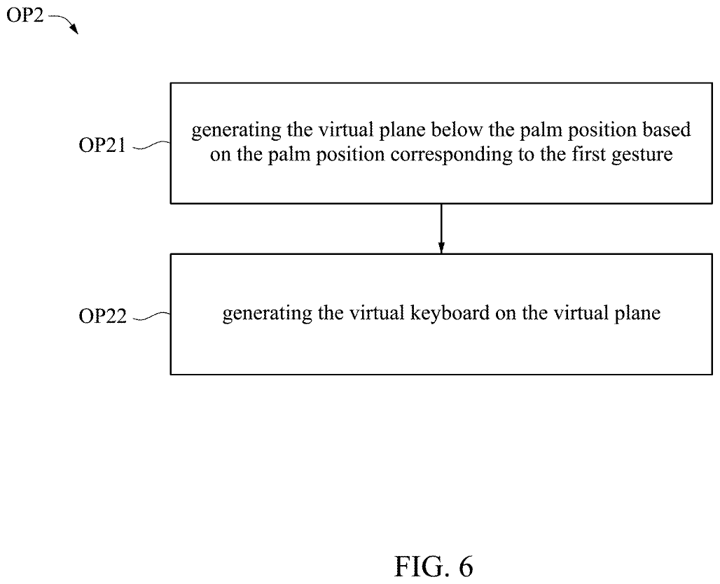

Reference is made to FIG. 6, in some embodiments, the operation OP12 further comprises the operation OP21-22.

First, in the operation OP21, the processor 12 generates the virtual plane below the palm position based on the palm position corresponding to the first gesture.

Finally, in the operation OP22, the processor 12 generates the virtual keyboard on the virtual plane.

For example, when both hands of the user U present the gesture G1 shown in FIG. 4, the processor 12 can calculate the position of two palms of the user U and generate a virtual plane below the palms (e.g., 5 centimeters below the palms). It is noted that, the virtual plane can be a horizontal plane or a plane adjusted based on the inclination of the user's gesture. For example, a plane parallel to the plane constructed by the user's palms generated based on the palms. Furthermore, the processor 12 generates the virtual keyboard VK on the virtual plane to make the virtual keyboard VK locate below the user's hands. Accordingly, the input apparatus 1 can simulate the situation of typing on a physical keyboard.

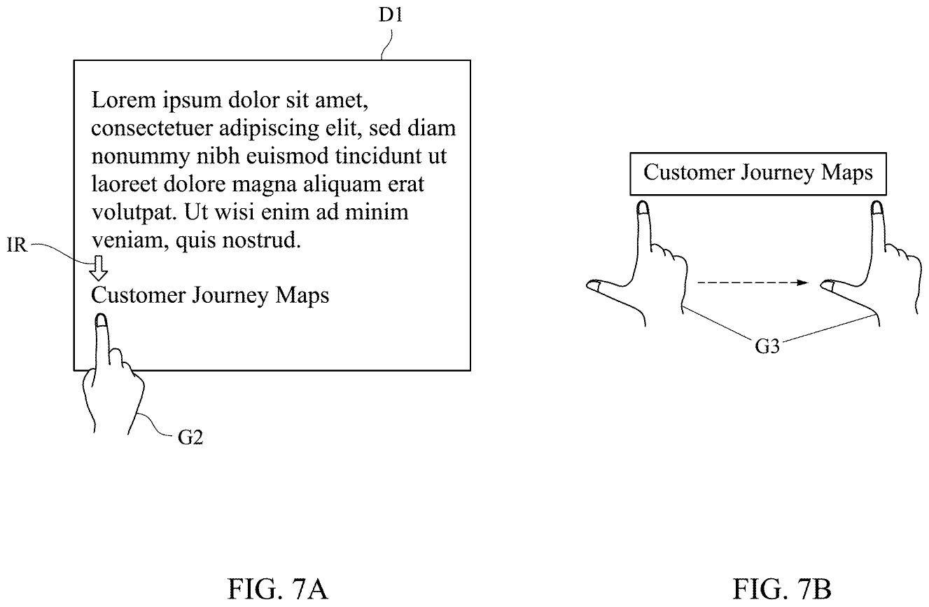

About the editing gestures mentioned in the operation OP4, please refer to FIGS. 7A, 7B, 8, 9A, and 9B, which are situational diagrams illustrating editing gestures G2-G5 according to some embodiments of the present disclosure.

In some embodiments, the processor 12 selects a cursor position based on one of a plurality of fingertip positions in the second hand images; and the processor 12 generates an input content based on the cursor position and the input command.

First, as shown in FIG. 7A, when the user U makes the editing gesture G2 extending the index finger, the processor 12 can move the cursor to the position of the fingertip of the index finger in the article presented in the display D1 to allow the user U to further enter texts at the position. In some embodiments, the input apparatus 1 can also generate an indicator IR at the position pointed by the gesture G2 to prompt the user U where the cursor moves.

In some embodiments, in response to the second gesture matching a selecting gesture, the processor 12 calculates a second moving path of one of a plurality of fingertips in the second hand images; and the processor 12 selects a plurality of texts based on the second moving path.

Next, as shown in FIG. 7B, when the user U makes the editing gesture G3 (i.e., the selecting gesture) extending the thumb and the index finger, the processor 12 can determine range of the selected texts based on the moving path of the fingertip of the index finger of the user U.

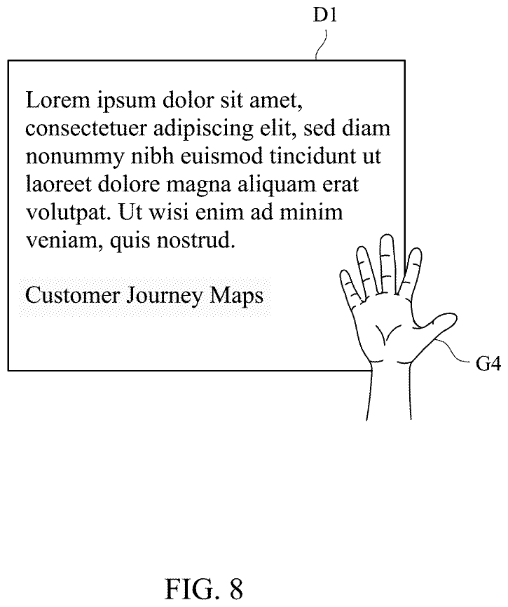

Next, as shown in FIG. 8, after selecting the texts, when the user U makes the editing gesture G4 facing the palm towards the camera 14, the processor 12 can copy the texts selected previously.

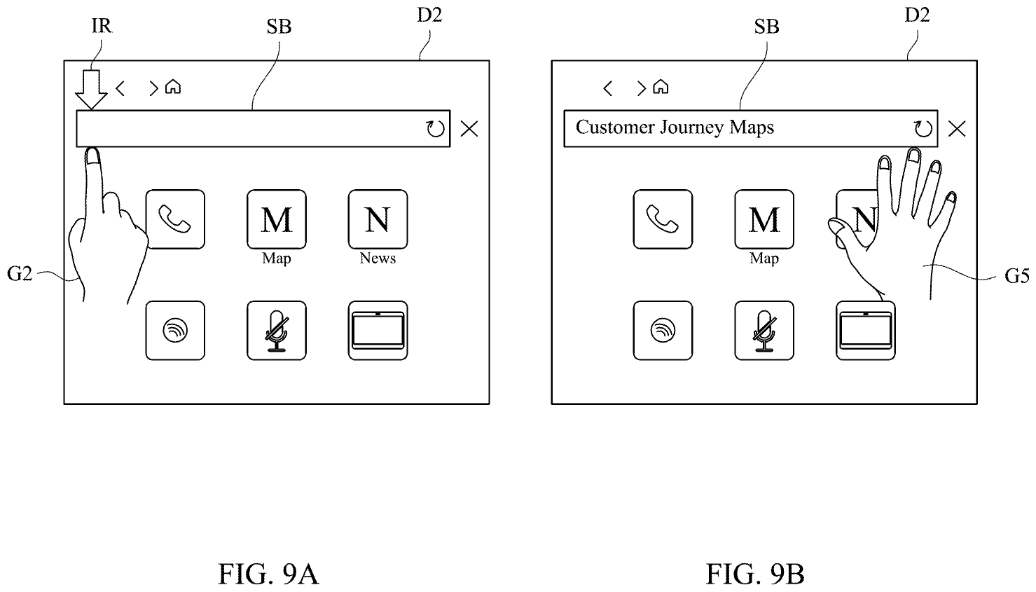

Next, as shown in FIG. 9A, after copying the texts, identically, the processor 12 can move the cursor to a search bar SB when the user U makes the gesture G2.

Finally, as shown in FIG. 9B, after moving the cursor, the processor 12 can paste the texts copied previously in the search bar SB when the user U makes the gesture G5 turning the back of the hand towards the camera 14.

According to the embodiments, the input apparatus 1 can execute the corresponding editing functions through recognizing the specific gestures of the user U. It is noted that, the editing gestures mentioned in the embodiments above is for illustration and the present disclosure is not limited thereto. In practice, the input apparatus 1 can set one or more gestures to trigger the above-mentioned functions or further set more gestures to execute other functions.

In some embodiments, the operation of generating the input command corresponding to the typing gesture further comprises: the processor 12 calculates a first moving path of each of a plurality of fingertips based on the second hand images; and in response to the first moving path of one of the fingertips perpendicular to the virtual plane, the processor 12 generates the input command of a key corresponding to the one of the fingertips.

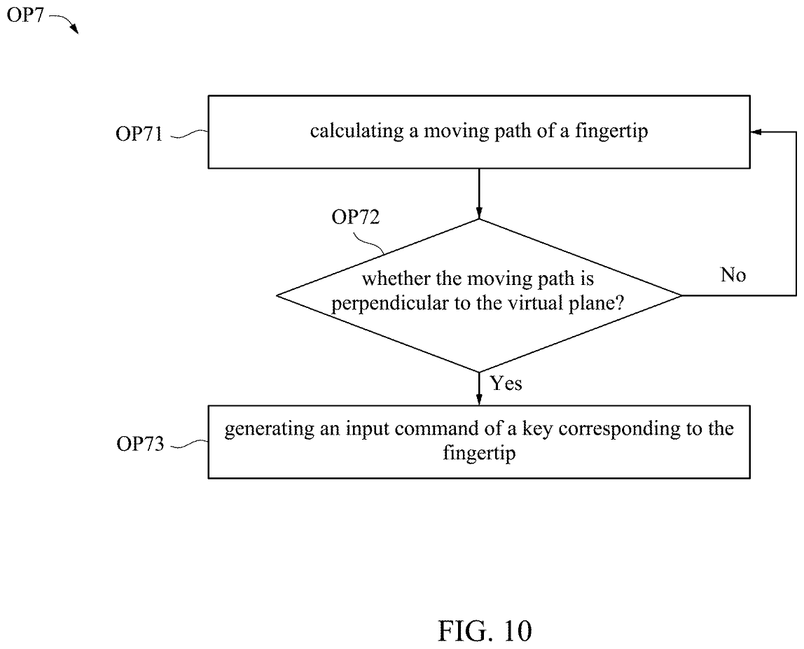

About the details of the typing gesture, please refer to FIG. 10, in some embodiments, the operation OP7 further comprises the operation OP71-OP73.

First, in the operation OP71, the processor 12 calculates the moving paths of the fingertips of the user U in the second hand images.

Next, in the operation OP72, the processor 12 determines whether each of the moving paths of the fingertips is perpendicular to the virtual plane. When the processor 12 determines that one of the moving paths of the fingertips is perpendicular to the virtual plane, the processor 12 executes the operation OP73. In contrast, when the processor 12 determines that none of the moving paths of the fingertips is perpendicular to the virtual plane, the processor 12 returns to the operation OP71.

Finally, in the operation OP73, the processor 12 generates an input command of a key corresponding to the fingertip.

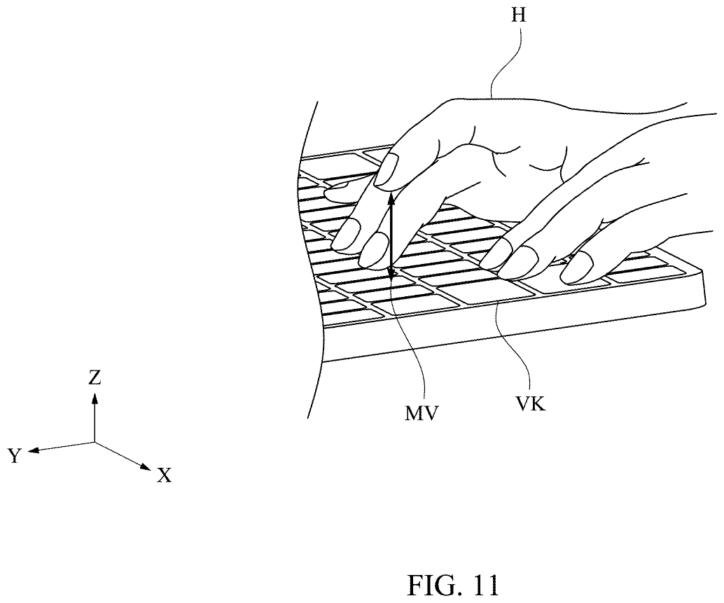

Specifically, as shown in FIG. 11, in the space constructed by the X, Y, and Z axes, the virtual keyboard VK is set on the X-Y plane (i.e., the virtual plane). In the operation OP71, the processor 12 tracks each of the fingertip positions of the hand H and calculates a moving path MV of the fingertip of the index finger accordingly. When the fingertip of the index finger moves back and forth once along the moving path MV, the processor 12 determines that the moving path MV is parallel to the Z axis and is perpendicular to the X-Y plane in the operation OP72. Accordingly, the processor 12 can executes the operation OP73, triggering the function of the key corresponding to the index finger of the hand H.

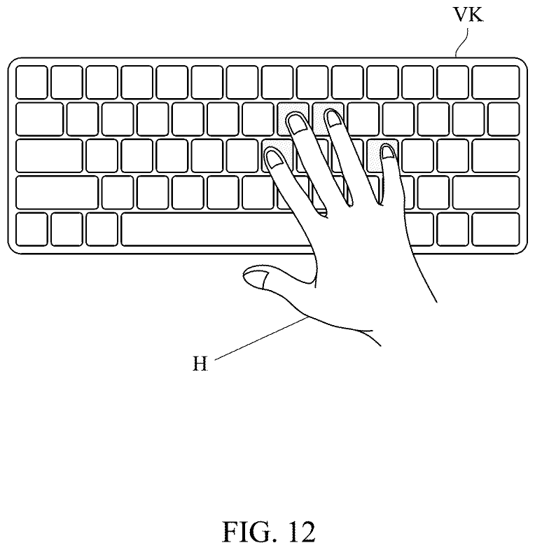

Reference is made to FIG. 12, in some embodiments, the input apparatus 1 can also mark the key corresponding to each of the fingers of the user U on the virtual keyboard VK. Specifically, the processor 12 calculates a plurality of fingertip positions in the second hand images; and the processor 12 calculates a key corresponding to each of the fingertip positions on the virtual keyboard.

For example, the processor 12 can track the fingertip positions of each of the fingers of the user U by using an image recognition model, further calculates the projection points of the fingertip positions on the virtual plane (i.e., the virtual keyboard VK), and determines the key corresponding to each of the fingers based on the projection points.

As shown in FIG. 12, the four fingers of the hand H of the user U are relatively above H, U, I, and L keys, and the input apparatus 1 marks the four keys in the virtual keyboard VK to prompt the user U.

In some embodiments, in response to the second gesture indicating the user changing from a hands-open pose to a hands-closed pose, the processor 12 determines that the second gesture matches the closing gesture.

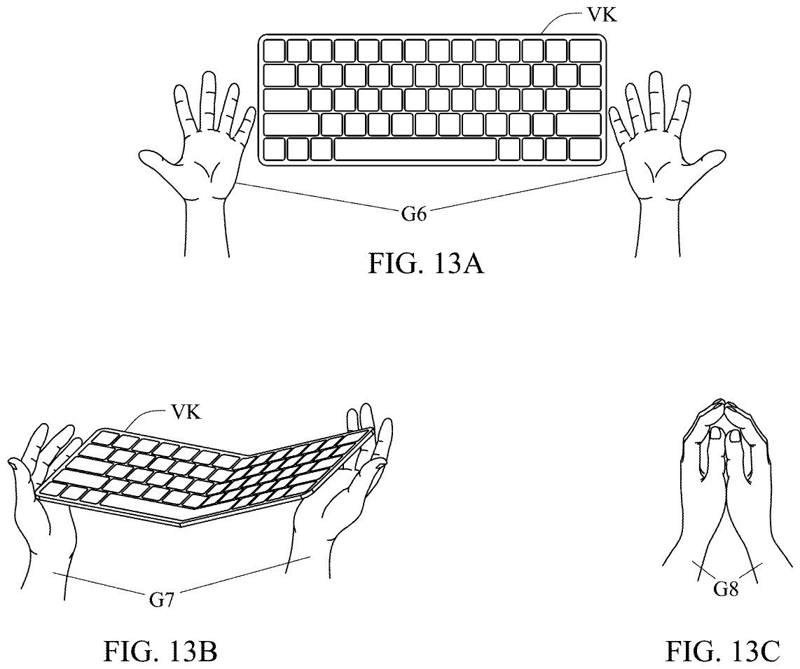

About the details of the closing gesture, please refer to FIG. 13A-13C, which are schematic diagrams illustrating closing gestures G6-G8 according to some embodiments of the present disclosure.

First, as the gesture G6 shown in FIG. 13A, both hands of the user U spread flatly on both sides of the virtual keyboard VK, and the palms turn towards the camera 14. Next, as the gesture G7 shown in FIG. 13B, the hands are gradually closing, and the input apparatus 1 close up the virtual keyboard VK correspondingly. Finally, as the gesture G8 shown in FIG. 13C, the hands are closed and complete the closing gesture, and the input apparatus 1 terminates the virtual keyboard VK correspondingly to end editing text.

According to the embodiments, the input apparatus 1 can terminate the virtual keyboard VK through recognizing the specific gestures of the user U. It is noted that, the editing gestures mentioned in the embodiments above is for illustration and the present disclosure is not limited thereto. In practice, the input apparatus 1 can set one or more gestures to terminate the virtual keyboard VK.

In summary, the input apparatus 1 in the present disclosure can generate and terminate a virtual keyboard on a virtual plane through recognizing the gestures of the user to provide text-editing functions without setting up a specific pattern or a physical plane in advance. Correspondingly, the input apparatus 1 can also execute key functions of the virtual keyboard through recognizing the gestures similar to operating the physical keyboards to provide intuitive operating experiences and reduce the learning difficulty of the user. Besides, the input apparatus 1 can further execute the corresponding editing functions through recognizing the gestures of the user to improve the convenience of text editing.

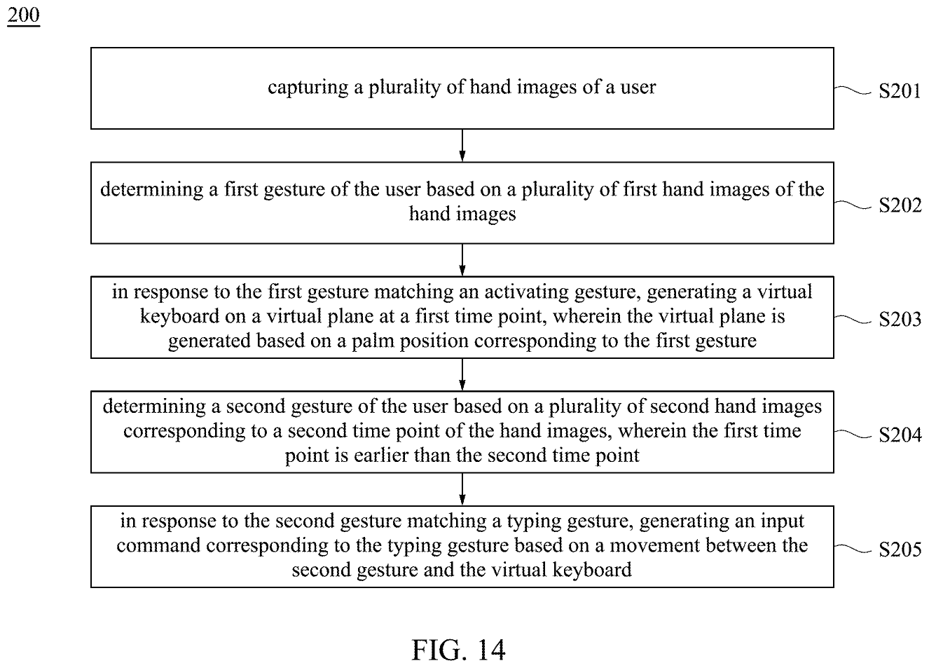

Reference is made to FIG. 14. FIG. 14 is a flow diagram illustrating an input method 200 according to a second embodiment of the present disclosure. The input method 200 comprises steps S201-S205. The input method 200 is configured to generate a virtual keyboard based on a gesture of a user and execute the corresponding function. The input method 200 can be executed by an electronic apparatus (e.g., the input apparatus 1 shown in FIG. 1).

First, in the step S201, the electronic apparatus captures a plurality of hand images of a user.

Next, in the step S202, the electronic apparatus determines a first gesture of the user based on a plurality of first hand images of the hand images.

Next, in the step S203, in response to the first gesture matching an activating gesture, the electronic apparatus generates a virtual keyboard on a virtual plane at a first time point, wherein the virtual plane is generated based on a palm position corresponding to the first gesture.

Next, in the step S204, the electronic apparatus determines a second gesture of the user based on a plurality of second hand images corresponding to a second time point of the hand images, wherein the first time point is earlier than the second time point.

Finally, in the step S205, in response to the second gesture matching a typing gesture, the electronic apparatus generates an input command corresponding to the typing gesture based on a movement between the second gesture and the virtual keyboard.

In some embodiments, the step S203 further comprises the electronic apparatus generating the virtual plane below the palm position based on the palm position corresponding to the first gesture; and the electronic apparatus generating the virtual keyboard on the virtual plane.

In some embodiments, the step S205 further comprises the electronic apparatus calculating a first moving path of each of a plurality of fingertips based on the second hand images; and in response to the first moving path of one of the fingertips perpendicular to the virtual plane, the electronic apparatus generating the input command of a key corresponding to the one of the fingertips.

In some embodiments, the input method 200 further comprises in response to the second gesture matching one of a plurality of editing gestures, the electronic apparatus executing an editing function corresponding to the one of the editing gestures.

In some embodiments, the input method 200 further comprises the electronic apparatus calculating a plurality of hand joint points in the hand images; and the electronic apparatus determining the first gesture and the second gesture based on the hand joint points.

In some embodiments, the input method 200 further comprises the electronic apparatus calculating a plurality of fingertip positions in the second hand images; and the electronic apparatus calculating a key corresponding to each of the fingertip positions on the virtual keyboard.

In some embodiments, the input method 200 further comprises in response to the second gesture matching a closing gesture, the electronic apparatus terminating the virtual keyboard.

In some embodiments, the input method 200 further comprises in response to the second gesture indicating the user changing from a hands-open pose to a hands-closed pose, the electronic apparatus determining that the second gesture matches the closing gesture.

In some embodiments, the input method 200 further comprises the electronic apparatus selecting a cursor position based on one of a plurality of fingertip positions in the second hand images; and the electronic apparatus generating an input content based on the cursor position and the input command.

In some embodiments, the input method 200 further comprises in response to the second gesture matching a selecting gesture, the electronic apparatus calculating a second moving path of one of a plurality of fingertips in the second hand images; and the electronic apparatus selecting a plurality of texts based on the second moving path.

In some embodiments, the input method 200 further comprises the electronic apparatus generating an indicator at the cursor position to indicate the user.

In summary, the input method 200 in the present disclosure can generate and terminate a virtual keyboard on a virtual plane through recognizing the gestures of the user to provide text-editing functions without setting up a specific pattern or a physical plane in advance. Correspondingly, the input method 200 can also execute key functions of the virtual keyboard through recognizing the gestures similar to operating the physical keyboards to provide intuitive operating experiences and reduce the learning difficulty of the user. Besides, the input method 200 can further execute the corresponding editing functions through recognizing the gestures of the user to improve the convenience of text editing.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An input apparatus, comprising:
a camera, configured to capture a plurality of hand images of a user; and
a processor, communicatively connected to the camera, configured to execute the following operations:
determining a first gesture of the user based on a plurality of first hand images of the hand images;
in response to the first gesture matching an activating gesture, generating a virtual keyboard on a virtual plane at a first time point, wherein the virtual plane is generated based on a palm position corresponding to the first gesture;
determining a second gesture of the user based on a plurality of second hand images corresponding to a second time point of the hand images, wherein the first time point is earlier than the second time point; and
in response to the second gesture matching a typing gesture, generating an input command corresponding to the typing gesture based on a movement between the second gesture and the virtual keyboard.

2. The input apparatus of claim 1, wherein the operation of generating the virtual keyboard further comprising:
generating the virtual plane below the palm position based on the palm position corresponding to the first gesture; and
generating the virtual keyboard on the virtual plane.

3. The input apparatus of claim 1, wherein the operation of generating the input command corresponding to the typing gesture further comprising:
calculating a first moving path of each of a plurality of fingertips based on the second hand images; and
in response to the first moving path of one of the fingertips perpendicular to the virtual plane, generating the input command of a key corresponding to the one of the fingertips.

4. The input apparatus of claim 1, wherein the processor is further configured to execute the following operations:
in response to the second gesture matching one of a plurality of editing gestures, executing an editing function corresponding to the one of the editing gestures.

5. The input apparatus of claim 1, wherein the processor is further configured to execute the following operations:
calculating a plurality of hand joint points in the hand images; and
determining the first gesture and the second gesture based on the hand joint points.

6. The input apparatus of claim 1, wherein the processor is further configured to execute the following operations:
calculating a plurality of fingertip positions in the second hand images; and
calculating a key corresponding to each of the fingertip positions on the virtual keyboard.

7. The input apparatus of claim 1, wherein the processor is further configured to execute the following operations:
in response to the second gesture matching a closing gesture, terminating the virtual keyboard.

8. The input apparatus of claim 7, wherein the processor is further configured to execute the following operations:
in response to the second gesture indicating the user changing from a hands-open pose to a hands-closed pose, determining that the second gesture matches the closing gesture.

9. The input apparatus of claim 1, wherein the processor is further configured to execute the following operations:
selecting a cursor position based on one of a plurality of fingertip positions in the second hand images; and
generating an input content based on the cursor position and the input command.

10. The input apparatus of claim 1, wherein the processor is further configured to execute the following operations:
in response to the second gesture matching a selecting gesture, calculating a second moving path of one of a plurality of fingertips in the second hand images; and
selecting a plurality of texts based on the second moving path.

11. An input method, being adapted for use in an electronic apparatus, comprising:
capturing a plurality of hand images of a user;
determining a first gesture of the user based on a plurality of first hand images of the hand images;
in response to the first gesture matching an activating gesture, generating a virtual keyboard on a virtual plane at a first time point, wherein the virtual plane is generated based on a palm position corresponding to the first gesture;
determining a second gesture of the user based on a plurality of second hand images corresponding to a second time point of the hand images, wherein the first time point is earlier than the second time point; and
in response to the second gesture matching a typing gesture, generating an input command corresponding to the typing gesture based on a movement between the second gesture and the virtual keyboard.

12. The input method of claim 11, wherein the step of generating the virtual keyboard further comprising:
generating the virtual plane below the palm position based on the palm position corresponding to the first gesture; and
generating the virtual keyboard on the virtual plane.

13. The input method of claim 11, wherein the step of generating the input command corresponding to the typing gesture further comprising:
calculating a first moving path of each of a plurality of fingertips based on the second hand images; and
in response to the first moving path of one of the fingertips perpendicular to the virtual plane, generating the input command of a key corresponding to the one of the fingertips.

14. The input method of claim 11, further comprising:
in response to the second gesture matching one of a plurality of editing gestures, executing an editing function corresponding to the one of the editing gestures.

15. The input method of claim 11, further comprising:
calculating a plurality of hand joint points in the hand images; and
determining the first gesture and the second gesture based on the hand joint points.

16. The input method of claim 11, further comprising:
calculating a plurality of fingertip positions in the second hand images; and
calculating a key corresponding to each of the fingertip positions on the virtual keyboard.

17. The input method of claim 11, further comprising:
in response to the second gesture matching a closing gesture, terminating the virtual keyboard.

18. The input method of claim 17, further comprising:
in response to the second gesture indicating the user changing from a hands-open pose to a hands-closed pose, determining that the second gesture matches the closing gesture.

19. The input method of claim 11, further comprising:
selecting a cursor position based on one of a plurality of fingertip positions in the second hand images; and
generating an input content based on the cursor position and the input command.

20. The input method of claim 11, further comprising:
in response to the second gesture matching a selecting gesture, calculating a second moving path of one of a plurality of fingertips in the second hand images; and
selecting a plurality of texts based on the second moving path.
